(19) United States
(12) Patent Application Publication
(10) Pub. No.: US 2020/0299029 A1
(43) Pub. Date: Sep. 24, 2020

(54) A WINE POURER AND AERATOR, AND LABEL INCORPORATING SAME

(71) Applicant: Johannes Christoffel ROSSOUW, Bellville, Cape Town (ZA)

(72) Inventor: Johannes Christoffel ROSSOUW, Bellville, Cape Town (ZA)

(21) Appl. No.: 16/755,081

(22) PCT Filed: Sep. 26, 2018
(86) PCT No.: PCT/IB2018/057455

§ 371 Date: Apr. 9, 2020

(30) Foreign Application Priority Data
Oct. 12, 2017 (ZA) 2017/06893

(51) Int. Cl. B65D 23/06; B65D 47/06; B01F 13/00; B01F 3/04

(52) U.S. Cl. CPC B65D 23/065; B65D 47/068; B01F 2215/0072; B01F 3/04794; B65D 2203/02; B01F 13/0022

(57) ABSTRACT

A resiliently flexible planar pourer (104) rollable into a tubular pouring shape suitable for placement into a mouth (400) and neck (402) of a vessel (100) to define an operating condition wherein it provides a flow path from the vessel (100) and wherein the pourer (104) presses against side walls of the neck (402) under its own resilience. The pourer (104) comprises an obstruction tab (106) foldable towards an obstructing condition wherein it projects towards an interior of the tubular pouring shape when the pourer (104) is in the operating condition so as to obstruct the flow path. The invention extends to a label comprising a body with a pourer (104) incorporated therein.

### CROSS-REFERENCE(S) TO RELATED APPLICATIONS

This application claims priority from South African provisional patent application number 2017/06893 filed on Dec. 10, 2017, which is incorporated by reference herein.

### FIELD OF THE INVENTION

This invention relates to a pourer and aerator for a liquid, and extends to a label incorporating such a pourer. The invention may be particularly suited for use when pouring wine from a wine bottle.

### BACKGROUND TO THE INVENTION

A wine pourer is a device used whilst pouring wine to ensure reduced dripping when wine is poured from a bottle. Various types of pourers are known, and these may be combined with aerators to aerate the wine whilst pouring it.

Wine is aerated when it is exposed to air, which allows oxidation and evaporation to occur. It is well known in the art that this may influence a wine's aromatic and taste properties, often for the better. It may also lead to softer tannins in the wine.

Aerators are specific devices used to rapidly aerate wine by exposing the wine to significant air quantities in a relatively short period of time. This may be achieved by exposing the wine to turbulent flow, thereby exposing more of the wine to air.

Pourers are available that are in a generally planar shape in a normal orientation and which may be wound into a column to fit within a mouth of a bottle of wine. These types of pourers are resiliently woundable so that it may press against the sides of the mouth of the bottle under its own resilience. This allows the pourer to remain in position on its own whilst wine is poured from the bottle and through its tubular shape.

The applicant is aware of an aerator and pourer combination device, where the device is of a planar shape capable of being wound into a spiral and inserted into a mouth of a bottle as the pourer described above. Protrusions are provided in a body of the device and may be formed by pressing and bending the protrusions from the planar body. Wine may flow over and around these protrusions when it travels through the tubular shape during pouring. The protrusions serve to disrupt a smooth flow path of the wine, thereby introducing a variety of flow conditions that causes turbulent flow, thereby exposing the wine to more air than what would have occurred during uninterrupted flow, thereby aerating the wine. The protrusions of this device are located near an exit of the tubular shape. The interruption of the flow path may result in an undesirable flow at the exit of the pourer which may cause spilling of the wine. Additionally, if the protrusions are formed by pressing the protrusions from the body of the pourer wine may leak through the apertures left at the original locations of the protrusions in the body, resulting in potentially more spilling and also requiring the pourer to be washed with difficulty before re-use.

The applicant is also aware of a pourer that is provided in a label of a bottle. A releasable strip is provided on the label that secures the pourer on the label. Releasing the strip by tearing it partially from the label allows a user to remove the pourer from the label. However, releasing the strip results in the strip protruding from the label, which may unfavourably affect the aesthetics of the wine label, and also bottle as a whole.

The present invention aims to address some of the drawbacks identified above, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a resiliently flexible planar pourer rollable into a tubular pouring shape suitable for placement into a mouth and neck of a vessel to define an operating condition wherein it provides a flow path from the vessel and wherein the pourer presses against side walls of the neck under its own resilience, and comprising an obstruction tab foldable towards an obstructing condition wherein it projects towards an interior of the tubular pouring shape when the pourer is in the operating condition so as to at least partially obstruct the flow path.

Further features provide for the obstruction tab to be located so that, in the operating condition of the pourer, it is located at an inner end of the pourer in the vessel.

A still further feature provides for the obstruction tab to include fold lines defining fold locations at which folding may result in different degrees of obstruction of the flow path.

Yet further features provide for the pourer to include at least one marker indicating to a user how to roll the pourer into its tubular pouring shape; and for the marker to indicate the desired flow direction of fluids flowing through the pourer.

Further features provide for the pourer to be manufactured from a plastics material, such as polyethylene terephthalate (PET) or polyvinyl chloride (PVC); for the plastics material to be covered in a metallic material such as aluminium; and for the pourer to be coated with a liquid-repellent material.

The invention extends to a label comprising a body with a pourer incorporated therein, a line of weakness on the body at least partially defining an outer periphery of the pourer, and a removal tab provided on the pourer being operable to separate the pourer from the body of the label along the line of weakness.

Further features provide for the label and/or pourer to be manufactured from a resiliently flexible planar material such that, upon separation from the label, the pourer may be rolled into a tubular pouring shape and placed into a mouth and neck of a vessel to define an operating condition wherein it provides a flow path from the vessel, with the pourer pressing against side walls of the neck under its own resilience.

A still further feature provides for the removal tab to be configured to serve as an obstruction tab when the pourer is in the operating condition, with the obstruction tab located at the inner end of the pourer in the vessel and being foldable towards an obstruction condition wherein it projects towards an interior of the tubular pouring shape of the pourer to obstruct the flow path. The obstruction tab may cause turbulent flow of liquid flowing through the flow path, thereby causing aeration of the liquid.

A yet further feature provides for the obstruction tab to include fold lines defining fold locations at which folding may result in different degrees of obstruction of the flow path.

Further features provide for the pourer to include at least one marker indicating to a user how to roll the pourer into its tubular pouring shape; and for the marker to indicate the desired flow direction of fluids flowing through the pourer.

Still further features provide for the pourer to be manufactured from a plastics material, such as polyethylene terephthalate (PET) or polyvinyl chloride (PVC); for the plastics material to be covered in a metallic material such as aluminium; and for the pourer to be coated with a liquid-repellent material.

An embodiment of the invention will now be described, by way of example only, with reference to the accompanying drawings.

### BRIEF DESCRIPTION OF THE DRAWINGS

In the drawings:

FIG. 1 is a three-dimensional view of a vessel including a label according to an exemplary embodiment of the invention;

FIG. 2 is a front view of the pourer of FIG. 1 separated from the label thereof;

FIG. 3A to 3C are views of the pourer of FIG. 2 folded into a tubular pouring shape;

FIGS. 4A and 4B are views of the vessel of FIG. 1 with the pourer of FIG. 2 in its operating condition inserted into the mouth and neck thereof;

FIG. 5 is a top view of the vessel of FIG. 4 with the pourer in its operating condition therein; and

FIG. 6 is a front view of an additional exemplary embodiment of a pourer in accordance with the invention.

### DETAILED DESCRIPTION WITH REFERENCE TO THE DRAWINGS

The present invention provides a label that has a pourer incorporated therein. The label is suitable for attachment to a container, and will typically be attached to a vessel such as a bottle, and often a wine bottle. The reason therefor will be apparent further below.

The pourer is of a type which comprises a resiliently flexible, substantially planar body which may be rolled into a tubular shape and placed into a mouth of the bottle to pour liquids therefrom.

The label includes a body, and the pourer is incorporated in the body. A line of weakness at least partially defines an outer periphery of the pourer on the label. A removal tab is provided on the pourer which may be used to remove the pourer from the label, typically by pulling thereon.

The pourer, upon removal from the label, may be rolled into a tubular shape which may be inserted into the mouth of the bottle so as so to locate within the neck of the bottle. The pourer may locate in the neck of the bottle under its own resilience, as it presses against the side walls of the neck. In this operating condition, the pourer creates a flow path for liquids to be poured from the bottle. The removal tab may also function as an obstruction tab, in that it may be folded to project into and obstruct the flow path in the operating condition of the pourer. This may result in turbulent flow as liquids flow around the obstructing tab. This may result in aeration of the liquids as more air, and therefore oxygen, may come into contact with the liquid. It will be apparent that the selected material must be such that the tab is not substantially affected from its location by the liquid flowing therearound. The tab may be folded so that it presses against an opposite side of the tubular shape, with the liquid pressing it tighter against the tubular shape to prevent it from returning to its original position.

Fold lines may be provided on the obstructing tab to indicate where it may be folded. Different fold lines may result in different degrees of protrusion into, and therefore obstruction, of the flow path, which may in turn lead to different levels of aeration of liquids. A marker may also be provided to indicate to a user how to roll the pourer into the desired tubular pouring shape.

After removal of the pourer from the mouth of the bottle, the pourer may be expected to substantially return to its original form under its own resilience, and may be stored for future use when required.

The pourer may also be provided separately from a label. In such a case, the tab will only serve as an obstructing tab, and not as a removal tab. In all other aspect, the pourer may function in the same manner.

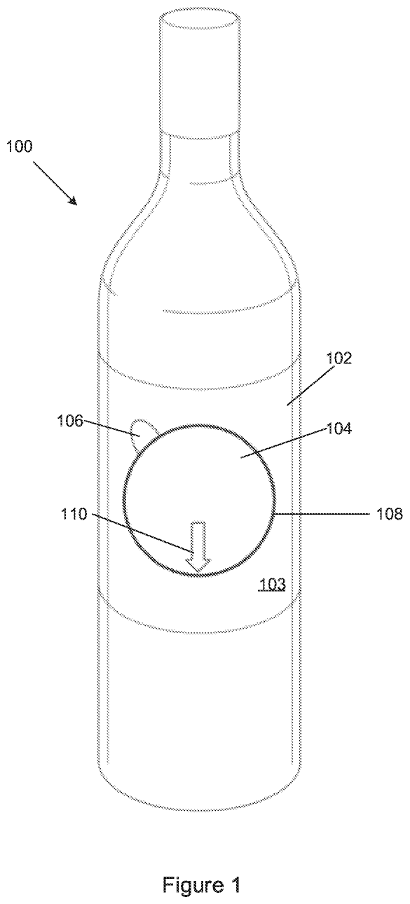

FIG. 1 shows a container, in the present embodiment a wine bottle (100), having a label (102) according to an exemplary embodiment of the invention attached thereto. The label (102) includes a body (103) with a pourer (104) incorporated therein. A line of weakness is provided on the body (103) that partially defines an outer periphery of the pourer. A removal tab (106) is provided on the pourer.

To separate and remove the pourer from the body (103) of the label (102), a user may pull on the removal tab (106). This should cause the line of weakness (108) to break or tear, thereby releasing the pourer from the label (102). The pourer may then be used as desired. A directional arrow (110) is provided on the pourer. Its purpose will be further described below.

In the present embodiment, the pourer is made of an aluminium-coated polyethylene terephthalate (PET) material.

It will be appreciated that in order to maintain the aesthetics of the bottle, the label may extend below the pourer as well as above it. Once the pourer is then removed from the body, the upper portion of the label which may have torn off when removing the pourer can be completely removed. Nevertheless, since the label is also provided below the pourer, the label or the image thereon may be kept substantially intact, thus maintaining the labels aesthetics at least to some extent.

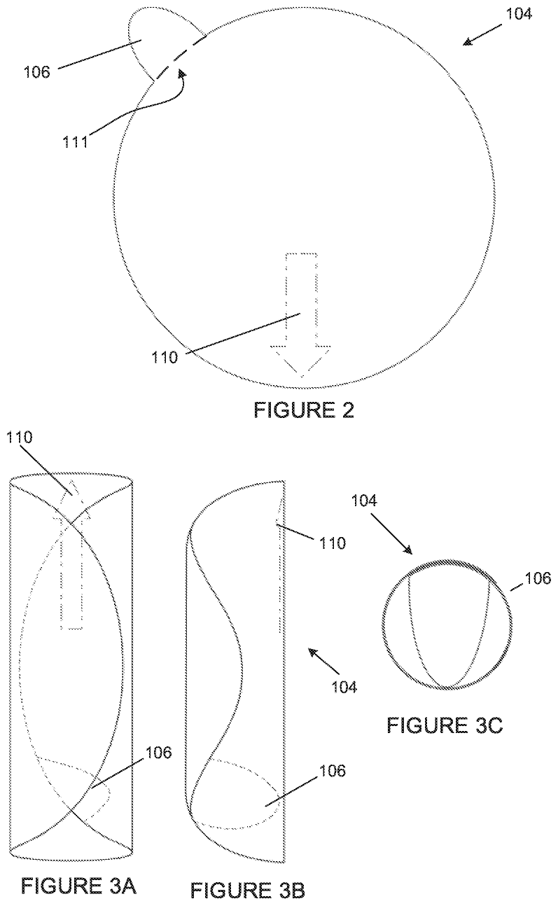

FIG. 2 shows a front view of the pourer (104) of FIG. 1 after it has been removed from the label (102). Like features are indicated by like reference numerals. As described above, a pourer according to the present invention may be provided separately from a label, and in the same format shown in FIG. 2. The removal tab (106) forms part of the pourer and has been removed therewith.

The pourer (104) has a disc-like shape and is manufactured from a resiliently flexible material. The resiliently flexible material allows the pourer (104) to be rolled into a tubular pouring shape as shown in FIGS. 3A to 3C. Like features are again indicated by like reference numerals. FIG. 3A shows a front view, FIG. 3B a side view, and FIG. 3C and end view of the pourer in a tubular pouring shape. It should be noted that the tab (106) is at an angle to the tubular shape of the pourer (104), and as a result it appears narrower in the end view than in its original condition of FIG. 2. It should be noted that the pourer (104) would need to be held in its rolled shape to remain therein due to its resiliently flexible nature.

The directional arrow (110) serves as a marker to indicate to a user how to roll the pourer into its tubular shape and where liquid should exit the pourer (104) when inserted into the neck of a bottle, thus indicating how the pourer (104) should be inserted into and used with a bottle. The pourer (104) should be rolled such that the directional arrow points outwards and in line with a mouth and neck of the bottle. It should be noted that the removal tab (106) has been folded to extend inwardly into a central channel provided by the tubular shape of the pourer (104). The removal tab (106) is folded on a line (111) provided where the tab (106) extends from the disc-shape thereof.

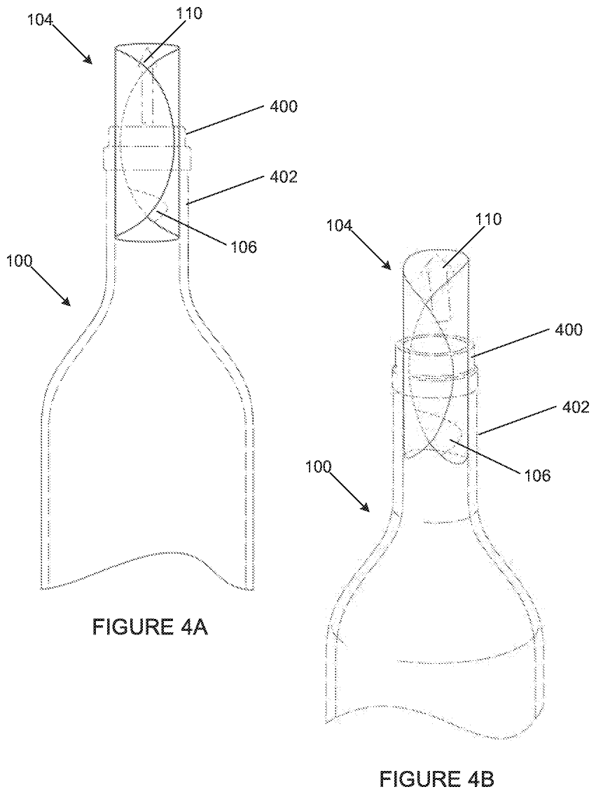

In the tubular pouring shape, the pourer (104) is suitable for insertion into a mouth and neck of the bottle (100) of FIG. 1. This is shown in FIGS. 4A and 4B, where like features of the pourer are indicated in like reference numerals to FIGS. 2 to 3C. FIG. 4A shows a partial front view, and FIG. 4B a partial three-dimensional view of the bottle (100) with the pourer (104) inserted therein. The bottle (100) is shown in broken lines to better illustrate the pourer (104). The pourer (104) may be inserted into the mouth (400) and neck (402) of the bottle so that it extends partially out of the mouth (400) thereof. As is shown, approximately the same length of pourer extends out of the mouth (400) as is held within the neck (402). A flow path is defined by the pourer (104) and extends through a central channel provided by the tubular shape thereof. When placed in the mouth (400) and neck (402) of the bottle (100), the pourer (104) may be released so that it presses against the side walls of the mouth (400) and neck (402) as a result of its own resilience. This forms a seal between the mouth (400) and neck (402) of the bottle and the pourer (104), preventing any liquid from flowing therebetween and spilling. Liquid can accordingly only flow from the bottle (100) through the flow path created by the pourer (104) and out of the free end of the pourer (104).

In the condition shown, the pourer (104) is in an operating condition. It may be expected that the pourer (104) is sufficiently resilient so that it remains in the operating condition shown during use. The flow path created by the pourer substantially aligns with a flow path defined by the neck (402) of the bottle (100).

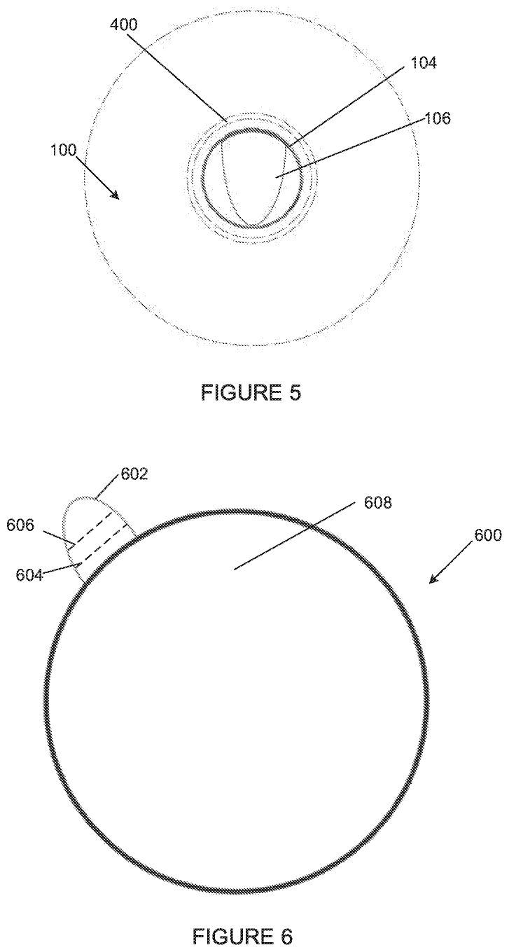

It should be noted that the removal tab (106) extends into the flow path, as can be more clearly seen in FIG. 5. When folded inwardly into the tubular shape and flow path in the manner shown, the removal tab (106) serves as an obstruction tab as it obstructs the normal flow path through the pourer (104). It should be noted that the material of the pourer is such that folding the tab causes it to substantially remain the folded condition, rather than returning to its original unfolded and non-obstructing condition. The pourer (104) is thus resiliently flexible, but not resiliently deformable. The removal tab (106) is located at an inner end of the tubular shape within the bottle as is clearly shown in FIGS. 4A and 4B. This, it will be appreciated, is not essential to the operation of the pourer, but if not followed could result in the pourer spilling substantially.

Wine may now be poured from the bottle. As a user pours wine, it attempts to flow through the flow path. However, as a result of the obstruction provided by the obstruction tab, it cannot do so freely. The obstruction tab prevents a normal free flowing stream, and may result in eddy currents and turbulent flow of the wine at the obstruction tab. This may result in more air, and therefore more oxygen, coming into contact with the wine. The wine may thereby be aerated. Tests conducted by the applicant have shown increased aeration of up to 60 percent when compared to conventional wine pourers.

Due to the location of the removal tab and therefore the induced turbulent flow within the bottle, flow at the opposite end at an exit of the pourer may be less violent than at the tab itself. This may prevent unnecessary spillage or violent pouring at the exit. The exit of the pourer may serve to prevent droplets from seeping down as is known in the art for existing planar-type pourers.

Additionally, the absence of protrusions extending from a body of the pourer itself may simplify cleaning of the pourer, as there are no apertures which need to be cleaned. Leaking during pouring may be similarly lessened by the present invention.

When the pourer is provided on its own, and not as part of a label, the removal tab will only function as an obstruction tab and will only be known as such.

When a user is done pouring liquid from the bottle, for example when the bottle is empty or when the user wishes to re-seal the bottle, the pourer may simply be withdrawn from the bottle. It may then be washed and may be used again at a later stage, particularly when a label of a bottle does not incorporate a similar pourer therein.

FIG. 6 shows a second exemplary embodiment of a pourer (600) according to the present invention. The pourer may again be provided on its own or as part of a label, as described above. The pourer includes an obstructing tab (602) which includes 2 fold lines (604, 606) thereon. The obstructing tab operates as that described above. However, the fold lines provide visual indicators indicating fold locations to a user where the obstructing tab may be folded. It will be apparent that the different fold lines may each lead to a different degree of protrusion into the flow path created in the rolled shape of the pourer. Furthermore, the marker indicating to a user how to roll the pourer into it tubular pouring shape is, in this embodiment, a thin broken line (608) as opposed to an arrow, which should line up with the neck of the bottle in the operating condition of the pourer.

It is envisaged that the pourer may be incorporated into a design applied to the label so that it does not negatively affect the aesthetics of the label, and therefore the entire bottle (100). A design may be provided underneath the pourer that integrates with the rest of the label after the pourer has been removed. This may be the same or notably different from the design applied to the pourer itself. A manufacturer or originator of the contents of the bottle may provide its logo or trade mark on the pourer so that it serves as advertising if a user uses the pourer, particularly with another brand of liquids at a later time.

A label according to the present invention may be suitable for use with different containers than the vessel in the form of a wine bottle used for illustrative purposes above. The pourer may similarly be usable with different containers, for example containers with different mouth and neck sizes, and the like. A pourer may be configured for use with a specific range of containers, of which wine bottles with a standard neck diameter is but one example.

The pourer need not be disc-like in appearance like the exemplary embodiments above. A number of suitable shapes may work with the present invention. Similarly, a differently shaped tab may perform equally well as either one or both of a removal tap and an obstructing tab, and may induce very specific flow profiles. A variety of marks, possibly more than one per pourer, may be provided to indicate to a user how to roll up and/or orient the pourer in a container.

The pourer may be oriented in any orientation on the label and on the bottle, and not just like it is shown in FIG. 1 above. The pourer may be oriented so that the removal tab is located in a specific orientation on the bottle, which may assist with removal, may prevent accidental removal during transport, or the like.

The marker may be provided at the back of the pourer when it is still attached to the label so that it is not visible to a user prior to its removal. This may impact the aesthetics of the label itself prior to removal of the pourer.

While only an aluminium-coated PET material is mentioned above, it is envisaged that the pourer may be made from any type of water-resistant paper, plastics material such as polyvinyl chloride, metallic material or metallic-coated material. It will be apparent that the selected material must have the necessary properties to provide the resiliently flexible nature required while at the same time being able to maintain the tab in its folded condition during pouring.

The above examples specifically indicate that the label may be used on wine bottles, and the pourer may be used when pouring wine, there may well be other containers and other liquids that may equally well be suitable for use with the present invention.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification unless the contents requires otherwise the word ‘comprise’ or variations such as ‘comprises’ or ‘comprising’ will be understood to imply the inclusion of a stated integer or group of integers but not the exclusion of any other integer or group of integers.

1. A pourer comprising:
a resiliently flexible planar pourer rollable into a tubular pouring shape suitable for placement into a mouth and neck of a vessel to define an operating condition wherein the pourer provides a flow path from the vessel and wherein the pourer presses against side walls of the neck under its own resilience; and
an obstruction tab foldable towards an obstructing condition wherein it projects towards an interior of the tubular pouring shape when the pourer is in the operating condition so as to at least partially obstruct the flow path provided by the pourer.

2. The pourer as claimed in claim 1, wherein the obstruction tab, in the operating condition of the pourer, is located at an inner end of the pourer in the vessel.

3. The pourer as claimed in claim 1, wherein the obstruction tab includes fold lines defining fold locations at which folding may result in different degrees of obstruction of the flow path.

4. The pourer as claimed in claim 1, wherein the pourer includes at least one marker indicating to a user how to roll the pourer into its tubular pouring shape.

5. The pourer as claimed in claim 1, wherein the pourer includes at least one marker to indicate the desired flow direction of fluids through the pourer.

6. The pourer as claimed in claim 1, wherein the pourer is manufactured from a plastics material.

7. The pourer as claimed in claim 6, wherein the plastics material is covered in a metallic material such as aluminium.

8. The pourer as claimed in claim 6, wherein the pourer is coated with a liquid-repellent material.

9. A label comprising:
a body with a pourer incorporated therein;
a line of weakness on the body at least partially defining an outer periphery of the pourer; and
a removal tab extending from the pourer and operable to separate the pourer from the body of the label along the line of weakness.

10. The label as claimed in claim 9, wherein the label and/or pourer are manufactured from a resiliently flexible planar material such that, upon separation from the label, the pourer may be rolled into a tubular pouring shape and placed into a mouth and neck of a vessel to define an operating condition wherein it provides a flow path from the vessel, with the pourer pressing against side walls of the neck under its own resilience.

11. The label as claimed in claim 9, wherein the removal tab is configured to serve as an obstruction tab when the pourer is in the operating condition, with the obstruction tab located at the inner end of the pourer in the vessel and being foldable towards an obstruction condition wherein it projects towards an interior of the tubular pouring shape of the pourer to obstruct the flow path.

12. The label as claimed in claim 11, wherein the obstruction tab includes fold lines defining fold locations at which folding may result in different degrees of obstruction of the flow path.

13. The label as claimed in claim 9, wherein the pourer includes at least one marker indicating to a user how to roll the pourer into its tubular pouring shape.

14. The label as claimed in claim 9, wherein the pourer includes at least one marker indicating the desired flow direction of fluids flowing through the pourer.
